(19) United States
(12) Patent Application Publication
(10) Pub. No.: US 2019/0042918 A1
(43) Pub. Date: Feb. 7, 2019

(54) REMOTE USAGE OF MACHINE LEARNED LAYERS BY A SECOND MACHINE LEARNING CONSTRUCT

(71) Applicant: Wave Computing, Inc., Campbell, CA (US)

(72) Inventors: Derek William Meyer, Truckee, CA (US); Christopher John Nicol, Campbell, CA (US)

(21) Appl. No.: 16/051,792

(22) Filed: Aug. 1, 2018

Related U.S. Application Data
(60) Provisional application No. 62/539,613, filed on Aug. 1, 2017.
(60) Provisional application No. 62/541,697, filed on Aug. 5, 2017.
(60) Provisional application No. 62/547,769, filed on Aug. 19, 2017.
(60) Provisional application No. 62/577,902, filed on Oct. 27, 2017.
(60) Provisional application No. 62/579,616, filed on Oct. 31, 2017.
(60) Provisional application No. 62/594,563, filed on Dec. 5, 2017.
(60) Provisional application No. 62/594,582, filed on Dec. 5, 2017.
(60) Provisional application No. 62/611,588, filed on Dec. 29, 2017.
(60) Provisional application No. 62/611,600, filed on Dec. 29, 2017.
(60) Provisional application No. 62/636,309, filed on Feb. 28, 2018.
(60) Provisional application No. 62/637,614, filed on Mar. 2, 2018.
(60) Provisional application No. 62/650,758, filed on Mar. 30, 2018.
(60) Provisional application No. 62/650,425, filed on Mar. 30, 2018.
(60) Provisional application No. 62/679,046, filed on Jun. 1, 2018.
(60) Provisional application No. 62/679,172, filed on Jun. 1, 2018.
(60) Provisional application No. 62/692,993, filed on Jul. 2, 2018.
(60) Provisional application No. 62/694,984, filed on Jul. 7, 2018.

(51) Int. Cl. G06N 3/04; G06N 3/08; G06F 15/18; H04W 4/46; H04W 4/44

(52) U.S. Cl. CPC G06N 3/0454; G06N 3/084; H04W 4/44; H04W 4/46; G06F 15/18

(57) ABSTRACT

Techniques are disclosed for remote usage of machine learned layers by a second machine learning construct. Layers determined within a first machine learning construct are sent to the second construct. A first data group is obtained in a first locality. The first data group is applied to a first localized machine learning construct. A first set of convolutional layers is determined within the first localized machine learning construct based on the first data group, where the first set of convolutional layers comprises a first data flow graph machine. Similarity is adjudicated between the first localized machine learning construct and a second localized machine learning construct. The first set of convolutional layers is sent to the second localized machine learning construct, based on the similarity that was adjudicated meeting a threshold. A second data group is analyzed by the second localized machine learning construct using the first set of convolutional layers.

### RELATED APPLICATIONS

This application claims the benefit of U.S. provisional patent applications “Remote Usage of Machine Learned Layers by a Second Machine Learning Construct” Ser. No. 62/539,613, filed Aug. 1, 2017, “Reconfigurable Fabric Operation Linkage” Ser. No. 62/541,697, filed Aug. 5, 2017, “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data analysis and more particularly to remote use of machine learned layers by a second machine learning construct.

### BACKGROUND

Data is a ubiquitous and valuable commodity that is collected for a wide array of purposes. Researchers, businesspeople, and governments collect and analyze vast amounts of data, and gather the data into datasets, commonly called, “big data”. The analysis of big data is nearly intractable using traditional computational techniques and processors because the sizes of the datasets vastly outstrip the capabilities of the processors and techniques employed previously. Data capture, storage, access, maintenance, transmission, and visualization further complicate the processing requirements attributable to the data analysis. These further requirements quickly saturate the traditional systems' capacities. The data would be all but valueless if there were no viable and scalable data analysis and handling techniques to meet the needs and uses of the data. Innovative computing architectures and software techniques, algorithms, heuristics, and so on, are necessitated. Those who own the datasets or have access to the datasets are motivated by business and research requirements to analyze the data contained within. Further purposes of the data also include business analysis, disease or infection detection, tracking, and control, crime detection and prevention, meteorology, and complex science and engineering simulations, to name but a very few. Advanced data analysis techniques are finding applications such as predictive analytics which can show consumers what they want, even before they know they do. Further approaches include applying machine learning and deep learning techniques in support of the data analysis.

Machine learning is a discipline of computer science that has expanded significantly with the advent of improved processor capabilities and better learning techniques. Machine learning has been described as the ability of a machine to learn about a dataset without the machine having to be explicitly programmed to handle that dataset. The learning, which can involve forming algorithms based on data within a dataset, can then be used to make predictions about further data within the dataset and other datasets. More specifically, the algorithms for data analysis are based on models, where the models are built based on the particular dataset. When a known dataset is used such as for structured learning, a model can be trained to look for similar patterns or characteristics in other datasets. Machine learning has been applied to a variety of difficult applications including email filtering to identify spam email, optical character recognition (OCR), computer vision, audio and image processing, and network intrusion detection, among many others. Machine learning techniques can range from “quick and dirty” approaches that can handle large amounts of data relatively quickly and with low to moderate effectiveness, to advanced techniques that, although more computationally intensive, can render decisions with relatively higher accuracy.

Reconfigurable hardware is a highly beneficial computing architecture that is particularly well suited to processing large data sets, performing complex computations, and other resource-intensive applications. Reconfigurable computing integrates to its advantage the key features of hardware and software techniques. A reconfigurable computing architecture can be “recoded” (reprogrammed or rescheduled) to adapt the high-performance hardware architecture to a variety of computational approaches, much like recoding software. An architecture based on a reconfigurable fabric hardware technique is directly applicable to reconfigurable computing. Reconfigurable fabrics may be arranged in a variety of configurations or topologies, where the topologies are coded, or programmed, for the many applications that require high performance computing. Applications such as processing of big data, digital signal processing (DSP), machine learning based on neural networks such as convolutional neural networks (CNN), deep neural networks (DNN), or recurrent neural networks (RNN), matrix computations, tensor computations, vector operations, Boolean manipulations, and so on, are successfully served by the capabilities of a reconfigurable fabric. The reconfigurable fabric operates particularly well when the data can include specific types of data, large quantities of unstructured data, sample data, and the like. The reconfigurable fabrics can be coded or scheduled to achieve these and other processing techniques, and to represent a variety of efficient computer architectures.

### SUMMARY

Machine learning techniques can be applied to planning, managing, or operating organizational structures such as retail establishments, or scheduling, managing, or configuring vehicles such as cars, motorcycles, vans, trucks, buses, etc. The machine learning techniques are used to process data obtained at a retail establishment or from a vehicle, and to learn machine learning layers from the data. The learning can include analyzing sales data from a retail establishment to identify trends based on location, season, customer demographics, customer buying habits, and so on, so that predictions can be made about how to maximize sales. Machine learning performed for a first retail establishment can be applied to a second retail establishment that is determined or adjudicated to be similar to the first retail establishment. Here, similarity can be gauged based on parameters such as market size, customer demographics, geographic location, etc. In the example of vehicles, the learning can include analyzing vehicle data to identify operational trends, operator preferences, or network data transfers, to maximize vehicle efficiency and operator enjoyment of the vehicle. Machine learning performed for a first vehicle can be applied to a second vehicle. Again, application of the machine learning based on a vehicle can be determined based on vehicle type, driver demographics, driver preferences, etc. Computational resource usage is greatly reduced by sharing and thereby reusing the learning about the similar retail establishments and the similar vehicles, since the machine learning techniques are not repeated.

Distributed machine learning layers are used for data analysis. Embodiments include a computer-implemented method for data analysis comprising: obtaining a first data group in a first locality; applying the first data group to a first localized machine learning construct; determining a first set of convolutional layers within the first localized machine learning construct based on the first data group, wherein the first set of convolutional layers comprises a first data flow graph machine; sending the first set of convolutional layers to a second localized machine learning construct; and analyzing a second data group by the second machine learning construct using the first set of convolutional layers.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for distributed machine learning layers.

FIG. 2 is a flow diagram for determining convolution layers.

FIG. 3 is a flow diagram for threshold update.

FIG. 4 shows a deep learning block diagram.

FIG. 5 illustrates convolutional layer transfer for retail establishments.

FIG. 6 shows car-to-car and car-to-mesh communication.

FIG. 7 shows scheduled sections relating to an agent.

FIG. 8 illustrates a server allocating FIFOs and processing elements.

FIG. 9 shows a cluster for coarse-grained reconfigurable processing.

FIG. 10 illustrates a block diagram of a circular buffer.

FIG. 11 illustrates a circular buffer and processing elements.

FIG. 12 is a system diagram for distributed machine learning layers.

### DETAILED DESCRIPTION

Techniques are disclosed for analyzing data for distributed machine learning layers. Machine learning can be performed using a network such as a neural network. Various neural network topologies can be used for the machine learning such as a deep neural network, a convolutional neural network, a recurrent neural network, and so on. A neural network can include a variety of layers such as input layers, output layers, hidden layers, etc. In order for the neural network to perform its machine learning tasks efficiently, the neural network must be trained. Training the neural network for machine learning is a painstaking process. While different training techniques exist, such as supervised training or unsupervised training, the training of the neural network requires processing of large amounts of data. The data, such as known data for supervised training, or unstructured data for unsupervised training, must be analyzed by the neural network as part of the training. The data analysis requires significant computational resources and time. Reuse of the machine learned layers of a first machine learning network by a second machine learning network obviates the need to train the second machine learning network “from scratch”. In some cases, the machine learning layers trained at one location or site can be applied to analysis of data obtained at another location or site. That is, a remote second localized machine learning construct can use machine learned layers learned by a first localized machine learning construct. Such distribution of machine learned layers can greatly increase efficiency by removing the need to retrain a machine learning system. Instead, the machine learning performed can be “reused” by applying it to a related scenario.

Distributed machine learning layers are applied to data analysis for data obtained in various contexts. Machine learning techniques can be applied to adjudicating a similarity between retail establishments, vehicles, and so on. When a similarity is judged to exist between contexts such as retail establishments or vehicles, then layers learned for one retail establishment or vehicle can be sent to another retail establishment or vehicle. This sending or sharing of the learned or trained machine learning layers can significantly reduce machine learning time through the reuse of the learned layers. Similarities between retail establishments can include square feet of retail space, product or service ranges offered, site location such as urban, suburban, or rural, and so on. Correspondingly, similarities between vehicles can include vehicle type such as motorcycle, car, van, sport utility vehicle, truck, bus, and the like.

Machine learning layers can be implemented using a network such as a neural network. A neural network can be based on a data flow graph, where the data flow graph includes nodes that perform computations, and arcs that indicate the flow of data between and among the nodes. The nodal computations can be performed by agents. The data flow graph for a given neural network can be implemented within a reconfigurable fabric, where a reconfigurable fabric comprises a plurality of processing elements. Processing elements within a reconfigurable fabric are configured to implement the data flow graph that represents the neural network. The reconfigurable fabric can include other elements such as processing elements, storage elements, switching elements, or communications paths. The data flow graph can implement machine learning or deep learning.

Computer-implemented data analysis can be applied to distributed machine learning layers. A first data group is obtained in a first locality. The first data group is applied to a first localized machine learning construct. The first learning construct can be a retail establishment, a vehicle, or group of vehicles, and so on. A first set of convolutional layers is determined within the first localized machine learning construct based on the first data group, where the first set of convolutional layers includes a first data flow graph machine. Similarity is adjudicated between the first localized machine learning construct and a second localized machine learning construct. The first set of convolutional layers is sent to the second localized machine learning construct, based on the similarity that was adjudicated meeting a threshold. The second localized machine learning construct can be similar to the first localized machine learning construct. A second data group is analyzed by the second localized machine learning construct using the first set of convolutional layers.

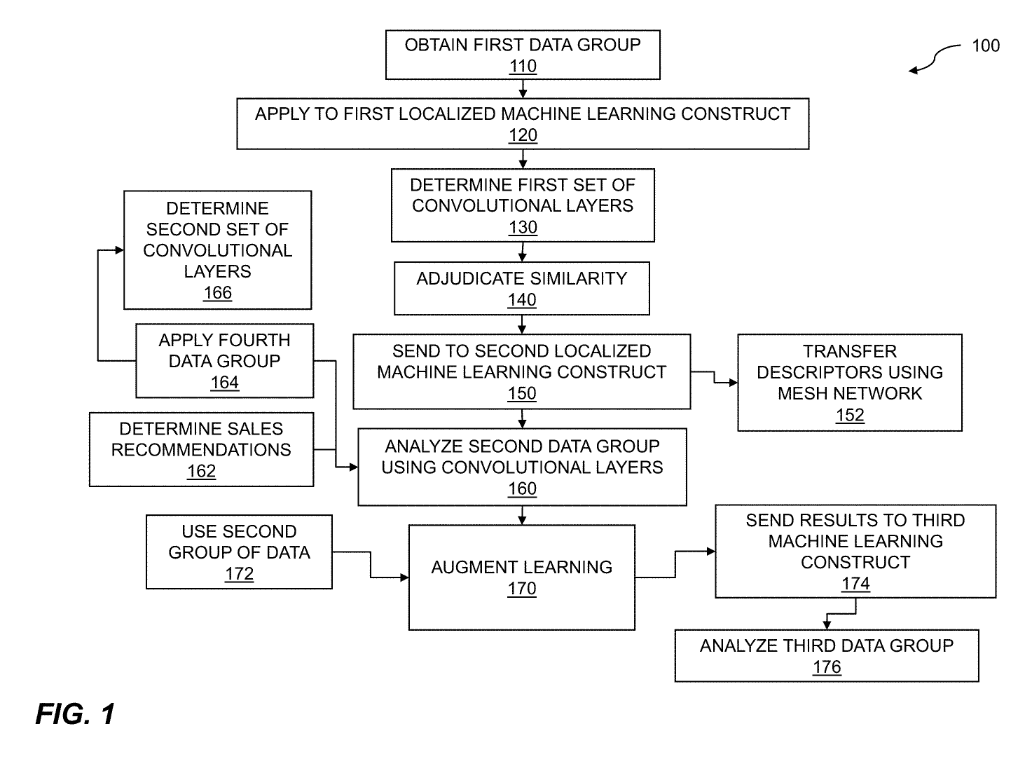

FIG. 1 is a flow diagram for distributed machine learning layers. The flow 100 includes obtaining a first data group 110 in a first locality. The first locality can include a physical location, such as a building, street address, a park or public space, and so on. The first locality can include the location of a vehicle, such as an automobile, a truck, a bus, a motorcycle, a bicycle, etc., and can include a street address, global positioning system (GPS) coordinates, and the like. The flow 100 includes applying the first data group to a first localized machine learning construct 120. The machine learning can be used to make predictions based on the obtained data. In embodiments, the first localized machine learning construct can include a first retail establishment. The first retail establishment can be large or small and can be located in a range of market sizes such as urban, suburban, rural, and so on. The first retail establishment can be part of a chain of retail establishments. In other embodiments, the first localized machine learning construct can include a retail establishment. The retail establishment can include a type of retail establishment such as a consumer retail establishment, a financial retail establishment, a travel retail establishment, etc. The first localized machine learning construct can be derived from other application fields different from retail. In embodiments, the first localized machine learning construct can include a first vehicle. The vehicle can include a motor vehicle such as an automobile, truck, or bus, a mechanized vehicle such as a bicycle, and so on. In embodiments, the applying the first data group to a first localized machine learning construct can include unsupervised learning. Unsupervised learning can infer a function that can describe a hidden structure in a dataset. The unsupervised learning can be based on clustering, anomaly detection, neural networks, and so on. In other embodiments, the applying the first data group to a first localized machine learning construct can include supervised learning. The supervised learning can be based on inferring a function to describe a structure in a dataset by training the learning using a known dataset. A known dataset includes known inputs and expected outputs.

The flow 100 includes determining a first set of convolutional layers 130 within the first localized machine learning construct based on the first data group wherein the first set of convolutional layers comprises a first data flow graph machine. The first data flow graph machine can be implemented by configuring and scheduling elements within a reconfigurable fabric. In embodiments, the determining a first set of convolutional layers can include machine learning. The machine learning can be based on a variety of techniques including artificial neural networks for deep learning, support vector machines (SVM), Bayesian networks, and so on. In embodiments, the first localized machine learning construct can include a convolutional neural net. As will be discussed later, a convolutional neural net can include various layers such as max pooling layers, hidden layers, weights, etc. A data-flow graph (DFG) can be used to represent data dependencies among various operations and processes. In other embodiments, the first localized machine learning construct can include a recurrent neural net.

The flow 100 includes adjudicating similarity 140 between the first localized machine learning construct and a second localized machine learning construct. Similarity can be based on a scaling factor, a percentage, a ratio, and so on. In embodiments, the similarity is based on a function such as a cosine similarity function. The cosine similarity function can provide a score or quantity relating to the similarity between two objects, such as the first localized machine learning construct and the second localized machine learning construct. In embodiments, the similarity can be adjudicated based on a machine learning construct context for the first localized machine learning construct and the second localized machine learning construct. The machine learning construct context can include the first localized machine learning construct and the second localized machine learning construct referencing retail establishments, vehicles, and the like.

The flow 100 includes sending the first set of convolutional layers to a second localized machine learning construct 150. The sending the first set of convolution layers can be based on the similarity that was adjudicated meeting a threshold. The threshold can be a value, a percentage, etc. The sending the first set of convolutional layers can be accomplished using a network such as a computer network or telephony network. The network can include a wired network, a wireless network, a hybrid network, and so on. The sending the first set of convolutional layers can be accomplished using a reconfigurable fabric. The second localized machine learning construct can be similar to or different from the first localized machine learning construct. In embodiments, the second localized machine learning construct can include a second retail establishment. The second retail establishment can be similar to the first retail establishment, where the similarity between the first and second retail establishments can be based on size, geographic location, market, customer demographics, and so on. In embodiments, the second localized machine learning construct can include a retail establishment. The retail establishment can include a consumer retail establishment, a financial retail establishment, and so on. In embodiments, the second localized machine learning construct can include a second data flow graph machine. The second data flow graph (DFG) can be used to represent data dependencies among various operations and processes. The sending can be based on the type of machine learning construct. In embodiments, the second localized machine learning construct comprises a second vehicle. The second vehicle can be either similar to or different from the first vehicle. In further embodiments, transferring descriptors for the first set of convolutional layers can include using a mesh network 152 comprising the first vehicle and the second vehicle. The mesh network can include two or more vehicles, where the two or more vehicles can be similar vehicles or different vehicles. The transferring descriptors can include using car-to-car networking.

The flow 100 includes analyzing a second data group by the second localized machine learning construct using the first set of convolutional layers 160. Recall that distributed machine learning, where the second localized machine learning construct performs analysis based on the first set of convolutional layers, can reduce computational requirements. The reduction in computational requirements is accomplished by reusing learned layers, weights, biases, etc. of the first localized machine learning construct, thereby saving training time. The analyzing can be used for a variety of purposes. In embodiments, the analyzing can include determining a sales recommendation 162 for a retail establishment associated with the second machine learning construct. The sales recommendation can include ordering stock, recommending mark-down items, sale items, and closeouts, etc. The flow 100 can further include applying a fourth data group 164 to the second localized machine learning construct. The fourth data group can be obtained from a fourth locality. The fourth data group can be used for training a network such as a convolutional neural network and for machine learning purposes. In embodiments, the flow 100 can include determining a second set of convolutional layers 166 on the second localized machine learning construct using the fourth data group. The second set of convolutional layers can be used in addition to the first set of convolutional layers, in place of the first set of convolutional layers, and so on.

The flow 100 includes augmenting learning 170 from the first localized machine learning construct by the second localized machine learning construct. The augmenting can be used to refine the second localized machine learning construct to handle nuances and differences between the first localized machine learning construct and the second localized machine learning construct. In embodiments, the augmenting learning is accomplished using a second group of data 172 obtained within the second localized machine learning construct. Recall that the second localized machine learning construct can be a retail establishment, a vehicle, and the like. The augmenting learning can be applied to the first localized machine learning construct, the second localized machine learning construct, or other localized machine learning constructs. In embodiments, the flow 100 includes sending results of the augmenting learning to a third machine learning construct 174. The third machine learning construct can be a retail establishment, a vehicle, etc. The flow 100 can further include analyzing a third data group 176 by the third machine learning construct using the results of the augmenting learning. The third data group can be obtained at a third location. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

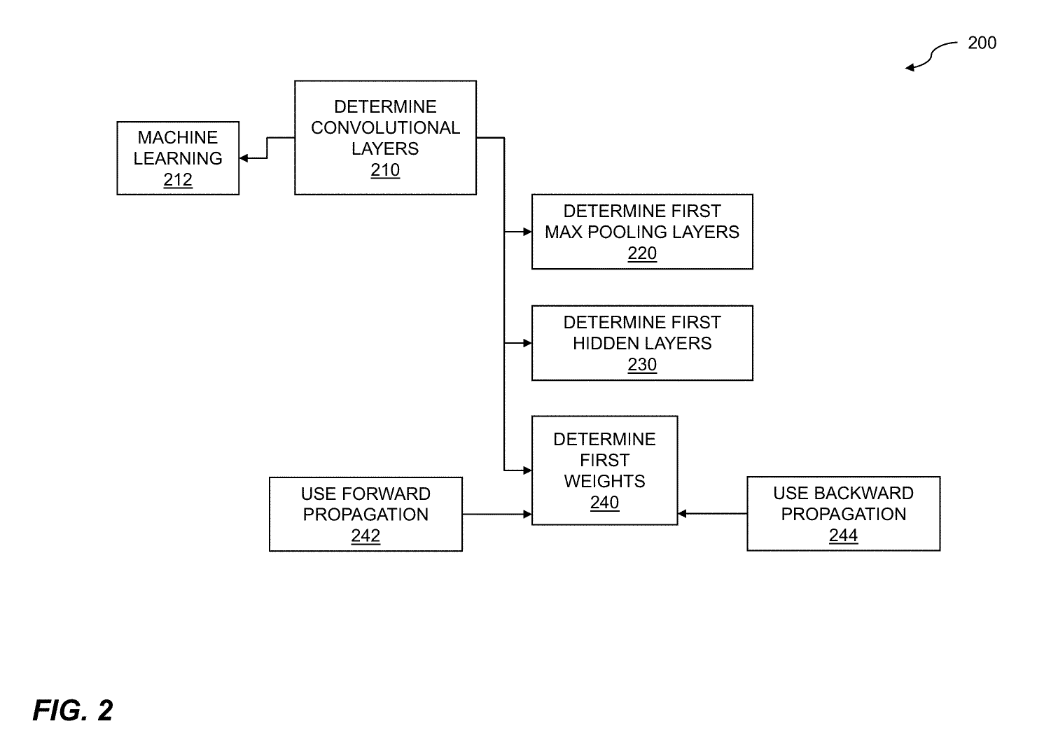

FIG. 2 is a flow diagram for determining convolutional layers. The determining convolutional layers can include data analysis for distributed machine learning layers. A first data group is obtained in a first locality. The first data group is applied to a first localized machine learning construct. The first learning construct can be a retail establishment, a vehicle, and so on. A first set of convolutional layers is determined within the first localized machine learning construct based on the first data group where the first set of convolutional layers includes a first data flow graph machine. Similarity is adjudicated between the first localized machine learning construct and a second localized machine learning construct. The first set of convolutional layers is sent to a second localized machine learning construct. The second localized machine learning construct can be similar to the first localized machine learning construct, based on the similarity that was adjudicated meeting a threshold. A second data group is analyzed by the second machine learning construct using the first set of convolutional layers.

The flow 200 includes determining a first set of convolutional layers 210 within the first localized machine learning construct. The determining the first set of convolutional layers is based on the first data group. The determining the first set of convolutional layers can include determining a number of layers, determining weights, biases, or parameters, and so on. The first set of convolutional layers includes a first data flow graph machine. The first data flow graph, which can include a network, can be implemented within a reconfigurable fabric. The network can include a neural network, where the neural network can include a deep neural network, a convolutional neural network, a recurrent neural network, and so on. In embodiments, the determining the first set of convolutional layers includes machine learning 212.

The flow 200 includes determining a first set of max pooling layers 220. Max pooling, which can be a form of pooling, can include a nonlinear function for down-sampling of data. Data can be partitioned into non-overlapping partitions, and the maximum of a given partition can be output. Down-sampled data can be analyzed with reduced computational requirements. The flow 200 includes determining a first set of hidden layers 230. Convolutional layers, including convolutional layers of a convolutional neural network, can include an input layer, hidden layers, an output layer, and so on. One or more hidden layers can be present. The one or more hidden layers can include elements or neurons, where the elements and neurons can be fully connected to elements and neurons of the previous layer. The elements and neurons of a given layer are independent of (not interconnected with) the other elements and neurons of the given layer. The hidden layers can perform various operations including max pooling of partitions of a previous layer. The flow 200 includes determining a first set of weights 240. Each element or neuron in a layer of a convolutional neural network can have a weight or bias. The weights can be learned by the convolutional neural network using supervised or unsupervised training, can be downloaded from the Internet or uploaded by a user, etc. The weights can be updated, tuned, and so on. In embodiments, the determining a first set of weights is accomplished using forward propagation 242. In forward propagation, weights are fed forward from one hidden layer in a convolutional neural network to the next layer in a convolutional neural network. In further embodiments, the determining a first set of weights is accomplished using backward propagation 244. In backward propagation, weights are fed back from one hidden layer in a convolutional neural network to the previous layer in a convolutional neural network. The various layers of the convolutional neural network can be tuned on the fly using forward propagation and/or backward propagation. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

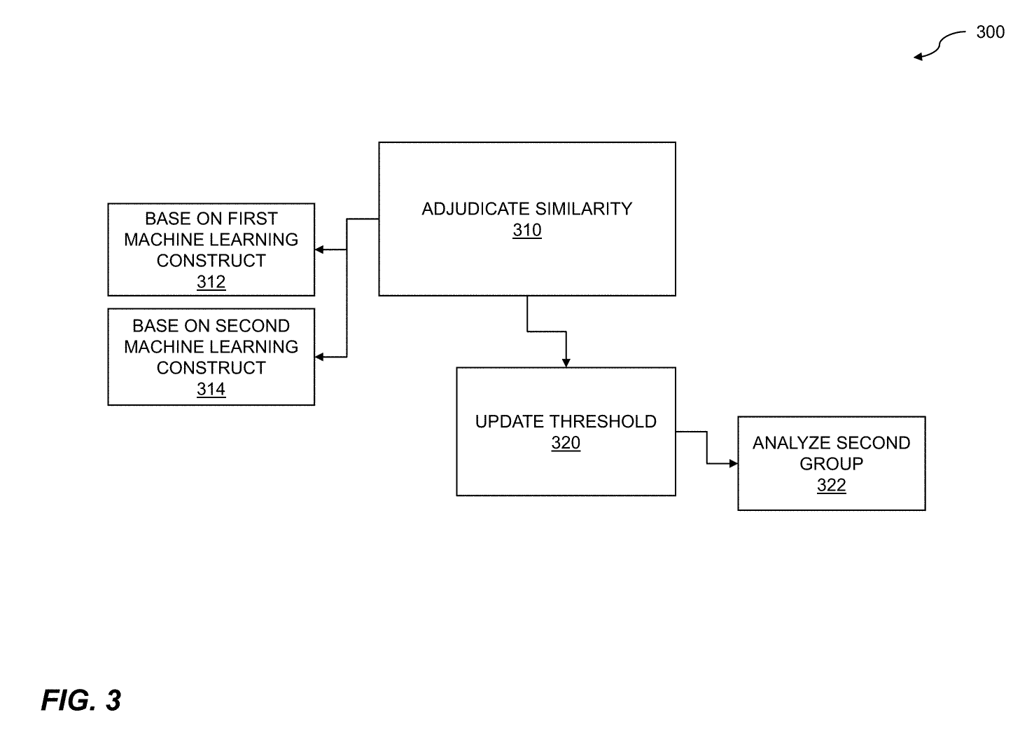

FIG. 3 is a flow diagram for threshold update. As discussed throughout, a first data group can be obtained in a first locality, and the first data group can be applied to a first localized machine learning construct. The first localized machine learning construct can include a retail establishment, a vehicle, and so on. A first set of convolutional layers is determined within the first localized machine learning construct based on the first data group, where the first set of convolutional layers can include a first data flow graph machine. The data flow graph machine can be implemented within a reconfigurable fabric. The data flow graph can represent a network such as a neural network, where the neural network can include a deep neural network, a convolutional neural network, a recurrent neural network, and the like. Similarity can be adjudicated between the first localized machine learning construct and a second localized machine learning construct, where the similarity can include similar retail establishments, similar vehicles, etc. The similarity can be based on size, location, or sales volume of a retail establishment, size, make, or model of a vehicle, etc. The first set of convolutional layers can be sent to the second localized machine learning construct, based on the similarity that was adjudicated meeting a threshold. The threshold can be a value, a scale, a percentage, and so on. A second data group can be analyzed by the second localized machine learning construct using the first set of convolutional layers. The threshold can be updated in support of distributed machine learning layers.

The flow 300 includes adjudicating similarity 310 between the first localized machine learning construct and a second localized machine learning construct. The similarity can be based on a type of localized machine learning construct. In a usage example, a localized machine learning construct can include a retail establishment. The retail establishment can include a size, such as a size of retail space, a location such as an urban, suburban, or rural location, a clientele based on demographics such as age, race, gender, household income, education, etc., a level of sales per period, and so on. A second retail establishment can be adjudicated to be similar to the first retail establishment based on size, location, clientele, sales figures, and so on. The localized machine learning construct can include a vehicle. Similarity between vehicles can include type, make, model, size, passenger count, load carry capacity, etc. In embodiments, the similarity is adjudicated based on machine learning construct context for the first localized machine learning construct 312 and the second localized machine learning construct 314. The machine learning construct context can include the first localized machine learning construct and the second localized machine learning construct referring to retail establishments, vehicles, and so on.

The flow 300 includes updating the threshold 320, where the threshold is updated based on the analyzing a second group of data 322 by the second localized machine learning construct. Recall that the threshold can be based on a type of localized machine learning construct such as a retail establishment, a vehicle, etc. The updating the threshold can include increasing or decreasing a value associated with the threshold, such as size, location, and so on. The updating the threshold can include changing a percentage to increase or decrease the likelihood of being adjudicated similar. The updating the threshold can include updating weights, biases, coefficients, factors, etc., of one or more layers within the data flow graph machine. The updating the threshold can include updating or adjusting weights using forward propagation and backward propagation.

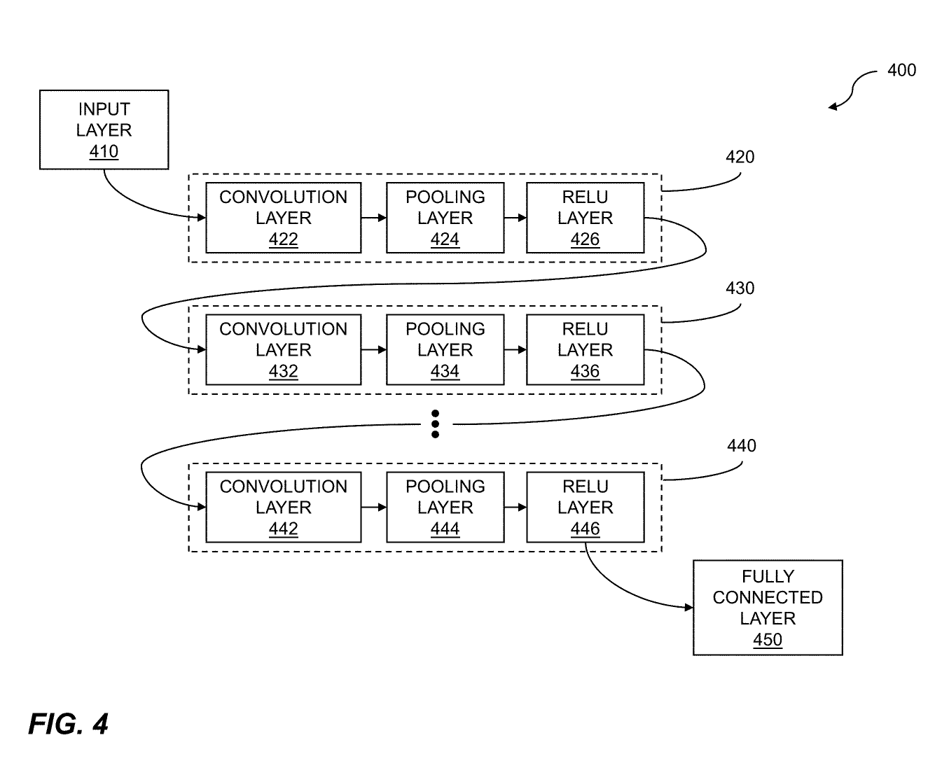

FIG. 4 shows a deep learning block diagram. The deep learning block diagram 400 can include a neural network such as a deep neural network (DNN), a convolutional neural network (CNN), a recurrent neural network, and so on. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform various operations such as logical operations. Deep learning can support distributed machine learning layers.

A deep learning block diagram 400 is shown. The block diagram can include various layers, where the layers can include an input layer, hidden layers, a fully connected layer, and so on. In some embodiments, the deep learning block diagram can include a classification layer. The input layer 410 can receive input data, where the input data can include a first obtained data group, a second obtained data group, a third obtained data group, a fourth obtained data group, etc. The obtaining of the data groups can be performed in a first locality, a second locality, a third locality, a fourth locality, and so on, respectively. The input layer can then perform processing such as partitioning obtained data into non-overlapping partitions. The deep learning block diagram 400, which can represent a network such as a convolutional neural network, can contain a plurality of hidden layers. While three hidden layers, hidden layer 420, hidden layer 430, and hidden layer 440 are shown, other numbers of hidden layers may be present. Each hidden layer can include layers that perform various operations, where the various layers can include a convolution layer, a pooling layer, and a rectified layer such as a rectified linear unit (ReLU) layer. Thus, layer 420 can include convolution layer 422, pooling layer 424, and ReLU layer 426; layer 430 can include convolution layer 432, pooling layer 434, and ReLU layer 436; layer 440 can include convolution layer 442, pooling layer 444, and ReLU layer 446. The convolution layers 422, 432, and 442 can perform convolution operations; the pooling layers 424, 434, and 444 can perform pooling operations, including max pooling, such as data down-sampling; the ReLU layers 426, 436, and 446 can perform rectification operations. A convolutional layer can reduce the amount of data feeding into a fully connected layer. The block diagram 400 can include a fully connected layer 450. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the cluster enters the configuration mode, various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processor can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

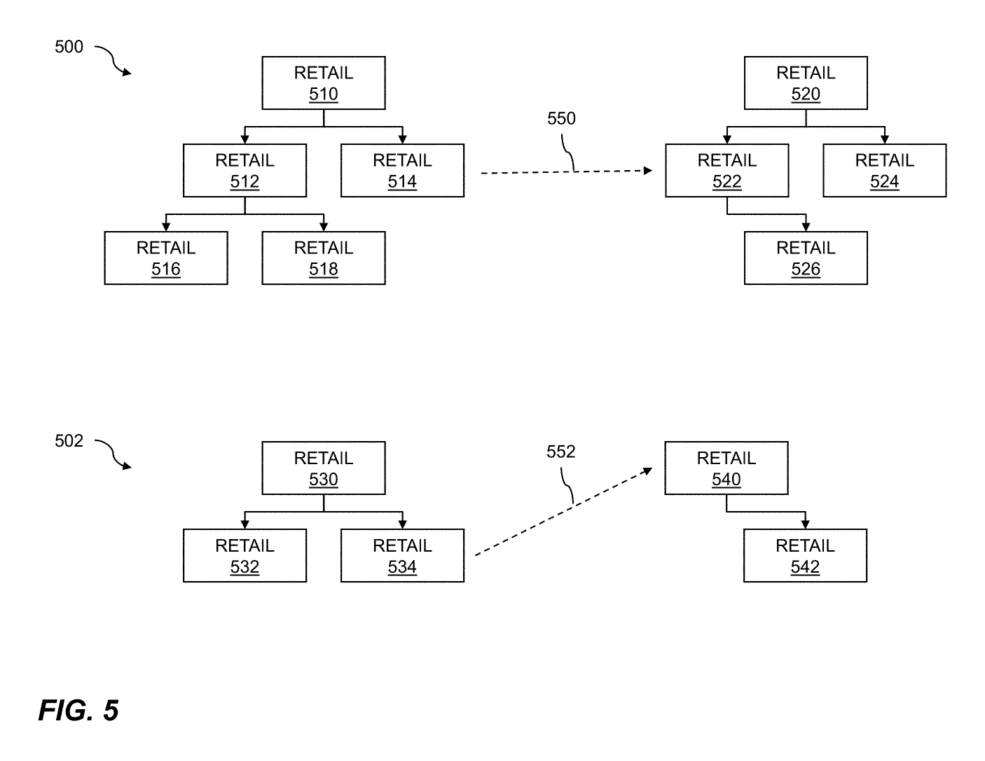

FIG. 5 illustrates convolutional layer transfer for retail establishments. One or more layers, including convolutional layers, can be transferred for distributed machine learning layers. The transfer can take place between a first localized machine learning construct and a second localized machine learning construct. The localized machine learning construct can include retail establishments. A first data group is obtained in a first locality, and the first data group is applied to a first localized machine learning construct. A first set of convolutional layers is determined within the first localized machine learning construct based on the first data group where the first set of convolutional layers includes a first data flow graph machine. Similarity is adjudicated between the first localized machine learning construct and a second localized machine learning construct. The similarity can be adjudicated based on machine learning construct context for the first localized machine learning construct and the second localized machine learning construct. The first set of convolutional layers is sent to a second localized machine learning construct, based on the similarity that was adjudicated meeting a threshold. A second data group is analyzed by the second localized machine learning construct using the first set of convolutional layers.

Convolutional layer transfer for retail establishments is shown, including two convolutional layer transfer examples 500 and 502. Convolutional layer transfer example 500 shows a first retail establishment which can include a hierarchical structure. Retail 510 can represent a headquarters or division, for example, while retail 512, retail 514, retail 516, and retail 518 can show various locations, franchises, etc. The structure can represent retail outlets in a large metropolitan area such as New York, Los Angeles, Washington D.C., etc. Data can be obtained from the retail localities, 510, 512, 514, 516, and 518, and a first set of convolutional layers can be determined. The first set of convolutional layers can be sent 550 to a second set of localities. The second set of localities can include retail 520, retail 522, retail 524, and retail 526. The second set of localities can be similar to the first set of localities in that the localities can share similar population sizes, demographics, climates, purchasing habits, etc. Convolutional layer transfer example 502 shows a third retail establishment which may include a hierarchical structure. Retail 530 can represent a headquarters, main branch, or division, for example, while retail 532 and 534 can show various locations, franchises, etc. The structure can represent retail outlets in a small or medium size metropolitan area, a rural state or area, etc. Data can be obtained from the retail localities, 530, 532, and 534, and a third set of convolutional layers can be determined. The third set of convolutional layers can be sent 552 to a fourth set of localities. The fourth set of localities can include retail 540 and retail 542. The fourth set of localities can be similar to the third set of localities in that population sizes, demographics, climates, etc., are comparable. The first and second localities, and the third and fourth localities do not have to be colocated within the same city, county, state, or country. Instead, they can share other commonalities such as climate, purchase habits, customer demographics, etc.

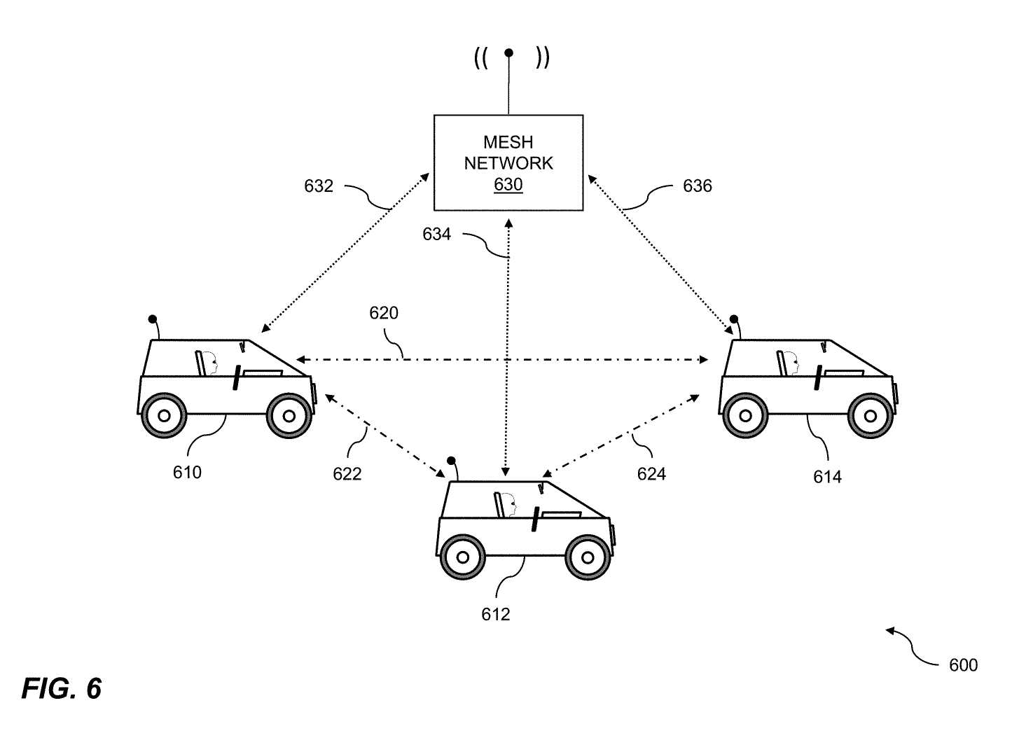

FIG. 6 shows car-to-car and car-to-mesh communication 600. Car-to-car, and car-to-mesh communication can support remote distributed machine learning layers. The communication can include wireless communication, where the wireless communication can be based on Wi-Fi, cellular, and other local area network (LAN) and wide area network (WAN) wireless communication techniques. A first data group is obtained in a first locality. The first data group is applied to a first localized machine learning construct. The first learning construct can be a retail establishment, a vehicle, and so on. A first set of convolutional layers is determined within the first localized machine learning construct based on the first data group where the first set of convolutional layers includes a first data flow graph machine. Similarity is adjudicated between the first localized machine learning construct and a second localized machine learning construct. The similarity can be adjudicated based on machine learning construct context for the first localized machine learning construct and the second localized machine learning construct. The first set of convolutional layers is sent to a second localized machine learning construct, based on the similarity that was adjudicated meeting a threshold. A second data group is analyzed by the second machine learning construct using the first set of convolutional layers. The threshold can be updated based on the analyzing a second group of data by the second localized machine learning construct.

Data can be obtained from localities, where the localities can include vehicles. The vehicles can include automobiles, trucks, buses, motorcycles, bicycles, etc. Three cars, 610, 612, and 614 are shown. While three cars are shown, other numbers of cars can participate in a car-to-car network. Wireless techniques can be used to send the first set of convolutional layers to a second localized machine learning construct. Car 610 can exchange information with car 614 along path 620, and with car 612 along path 622. Car 614 can exchange information with car 610 along path 620, and with car 612 along path 624. Car 612 can exchange information with car 610 along path 622, and with car 614 along path 624. In further embodiments, transferring descriptors for the first set of convolutional layers can use a mesh network 630 comprising the first vehicle, the second vehicle, and other vehicles. Each vehicle can have a communication path to the mesh network 630, such as path 632 between car 610 and mesh network 630, path 634 between car 612 and mesh network 630, and path 636 between car 614 and mesh network 630. The mesh network can include other numbers of mesh nodes that can make up the mesh network 630. Thus, vehicles 610, 612, and 614 can communicate with each other through the mesh network 630. Communication through the mesh network can eliminate the hidden transmitter problem which can limit communication speed and reliability.

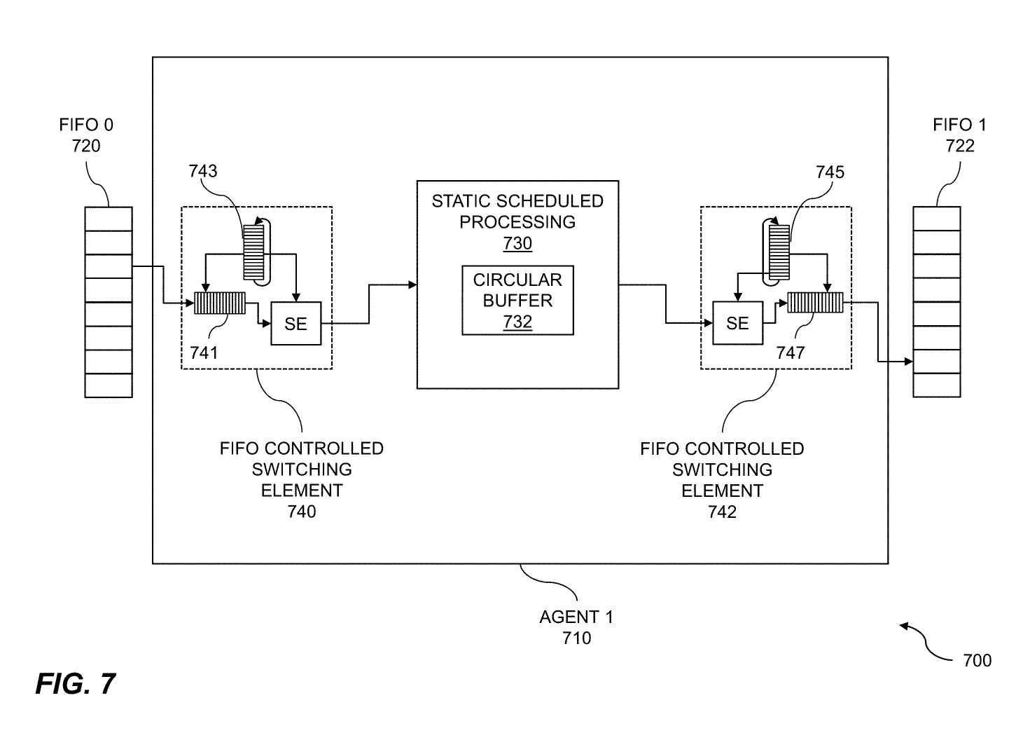

FIG. 7 shows scheduled sections relating to an agent 700. An agent can be one of a plurality of agents which support distributed machine learning layers. A first data group is obtained in a first locality and is applied to a first localized machine learning construct. A first set of convolutional layers is determined, where the first set of convolutional layers includes a first data flow graph machine. Similarity is adjudicated between the first localized machine learning construct and a second localized machine learning construct, and the first set of convolutional layers is sent to the second localized machine learning construct, based on the similarity meeting a threshold. A second data group is analyzed by the second localized machine learning construct using the first set of convolutional layers.

The figure shows an example 700 of scheduled sections relating to an agent. A FIFO 720 serves as an input FIFO for a control agent 710. Data from FIFO 0 720 is read into local buffer 741 of FIFO controlled switching element 740. Circular buffer 743 may contain instructions that are executed by a switching element (SE), and may modify data based on one or more logical operations, including, but not limited to, XOR, OR, AND, NAND, and/or NOR. The plurality of processing elements can be controlled by circular buffers. The modified data may be passed to a circular buffer 732 under static scheduled processing 730. Thus, the scheduling of circular buffer 732 may be performed at compile time. The instructions loaded into circular buffer 732 may occur as part of a program initialization and may remain in the circular buffer 732 throughout the execution of the program (control agent). The circular buffer 732 may provide data to FIFO controlled switching element 742. Circular buffer 745 may rotate to provide a plurality of instructions/operations to modify and/or transfer data to data buffer 747, which is then transferred to external FIFO 722.

A process agent can include multiple components. An input component handles retrieval of data from an input FIFO. For example, agent 710 receives input from FIFO 720. An output component handles the sending of data to an output FIFO. For example, agent 710 provides data to FIFO 1 722. A signaling component can signal to process agents executing on neighboring processing elements about conditions of a FIFO. For example, a process agent can issue a FIRE signal to another process agent operating on another processing element when new data is available in a FIFO that was previously empty. Similarly, a process agent can issue a DONE signal to another process agent operating on another processing element when new space is available in a FIFO that was previously full. In this way, the process agent facilitates communication of data and FIFO states among neighboring processing elements to enable complex computations with multiple processing elements in an interconnected topology.

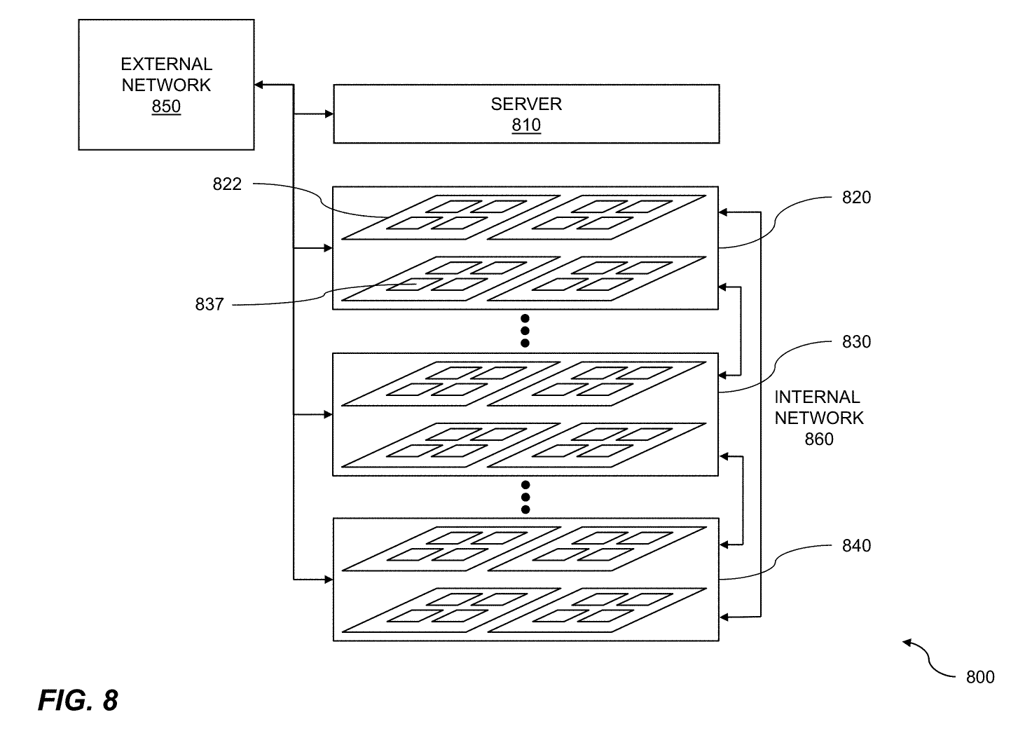

FIG. 8 illustrates a server allocating FIFOs and processing elements. First in first out (FIFO) techniques can be used to support distributed machine learning layers. The FIFOs can be scheduled, coded, or programmed to configure the processing elements, where the processing elements can be located within a reconfigurable fabric. The processing elements can be configured to implement distributed machine learning layers. A first data group is obtained in a first locality and is applied to a first localized machine learning construct. A first set of convolutional layers is determined where the first set of convolutional layers include a first data flow graph machine. Similarity is adjudicated between the first localized machine learning construct and a second localized machine learning construct. The first set of convolutional layers is sent to the second localized machine learning construct, based on the similarity meeting a threshold, and a second data group is analyzed by the second localized machine learning construct using the first set of convolutional layers.

In embodiments, system 800 includes one or more boxes, indicated by callouts 820, 830, and 840. Each box may have one or more boards, indicated generally as 822. Each board comprises one or more chips, indicated generally as 837. Each chip may include one or more processing elements, where at least some of the processing elements may execute a process agent. An internal network 860 allows for communication between the boxes such that processing elements on one box can provide and/or receive results from processing elements on another box.

The server 810 may be a computer executing programs on one or more processors based on instructions contained in a non-transitory computer readable medium. The server 810 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 810 may receive instructions and/or input data from external network 850. The external network may provide information that includes, but is not limited to, hardware description language instructions (e.g. Verilog, VHDL, or the like), flow graphs, source code, or information in another suitable format.

The server 810 may obtain performance statistics on the operation of the collection of processing elements. The performance statistics can include the number of fork operations, the number of join operations, average sleep time of a processing element, and/or a histogram of the sleep time of each processing element. Any outlier processing elements that sleep more than a predetermined threshold can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 810 may serve as an allocation manager to process requests for adding or freeing FIFOs, and/or changing the size of existing FIFOs in order to optimize operation of the processing elements.

In some embodiments, the server may receive optimization settings from the external network 850. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 810 can perform a reconfiguration based on user-specified parameters via external network 850.

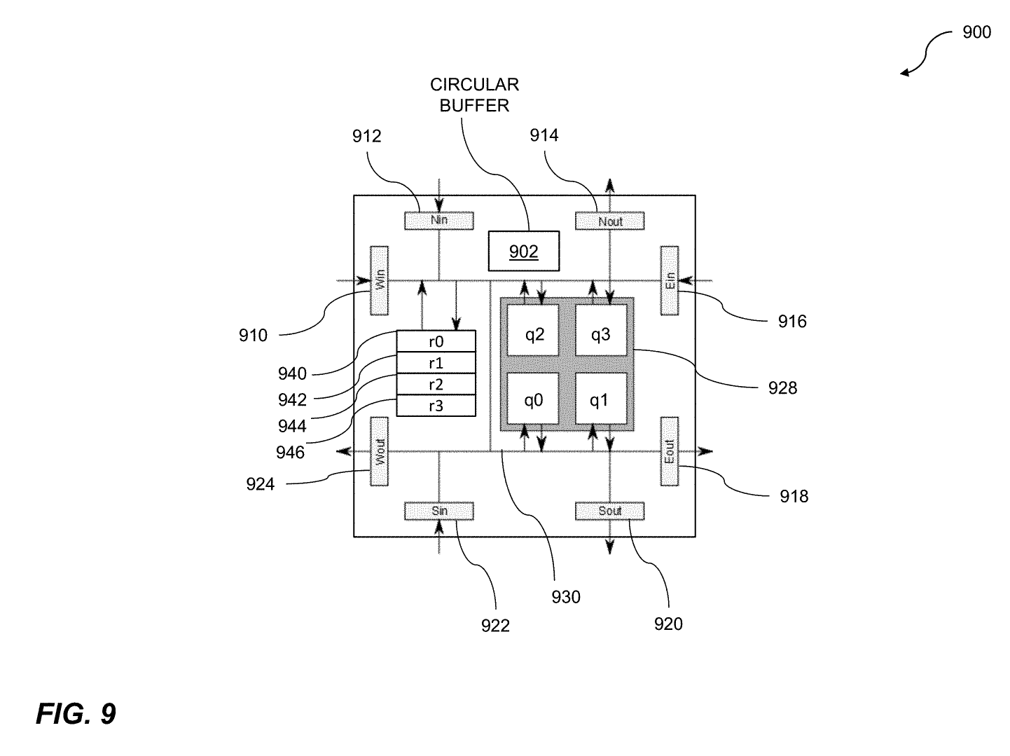

FIG. 9 shows a cluster for coarse-grained reconfigurable processing. The cluster for coarse-grained reconfigurable processing 900 can be used for distributed machine learning layers. The distributed machine learning layers include obtaining a first data group in a first locality and applying the first data group to a first localized machine learning construct. The first learning construct can be a retail establishment, a vehicle, and so on. A first set of convolutional layers is determined within the first localized machine learning construct based on the first data group where the first set of convolutional layers includes a first data flow graph machine. Similarity is adjudicated between the first localized machine learning construct and a second localized machine learning construct. The first set of convolutional layers is sent to the second localized machine learning construct, based on the similarity that was adjudicated meeting a threshold, and a second data group is analyzed by the second localized machine learning construct using the first set of convolutional layers.

The cluster 900 comprises a circular buffer 902. The circular buffer 902 can be referred to as a main circular buffer or a switch-instruction circular buffer. In some embodiments, the cluster 900 comprises additional circular buffers corresponding to processing elements within the cluster. The additional circular buffers can be referred to as processor instruction circular buffers. The example cluster 900 comprises a plurality of logical elements, configurable connections between the logical elements, and a circular buffer 902 controlling the configurable connections. The logical elements can further comprise one or more of switching elements, processing elements, or storage elements. The example cluster 900 also comprises four processing elements-q0, q1, q2, and q3. The four processing elements can collectively be referred to as a “quad,” and can be jointly indicated by a grey reference box 928. In embodiments, there is intercommunication among and between each of the four processing elements. In embodiments, the circular buffer 902 controls the passing of data to the quad of processing elements 928 through switching elements. In embodiments, the four processing elements 928 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 900 can further comprise storage elements coupled to the configurable connections. As shown, the cluster 900 comprises four storage elements-r0 940, r1 942, r2 944, and r3 946. The cluster 900 further comprises a north input (Nin) 912, a north output (Nout) 914, an east input (Ein) 916, an east output (Eout) 918, a south input (Sin) 922, a south output (Sout) 920, a west input (Win) 910, and a west output (Wout) 924. The circular buffer 902 can contain switch instructions that implement configurable connections. For example, an instruction effectively connects the west input 910 with the north output 914 and the east output 918 and this routing is accomplished via bus 930. The cluster 900 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 902. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 924 to an instruction placing data on the south output 920, such that the data can be output on both output ports within the same pipeline cycle. In a case where data needs to travel to a cluster that is both south and west of the cluster 900, it can be more efficient to send the data directly to the south output port rather than to store the data in a register first, and then to send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions North, East, South, West, a switch register, one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in excessive instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A” to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. Once the clusters enter the configuration mode, various techniques, including direct memory access (DMA) can be used to load instructions from the kernel into instruction memories of the PEs. The clusters that were preprogrammed to enter configuration mode can also be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

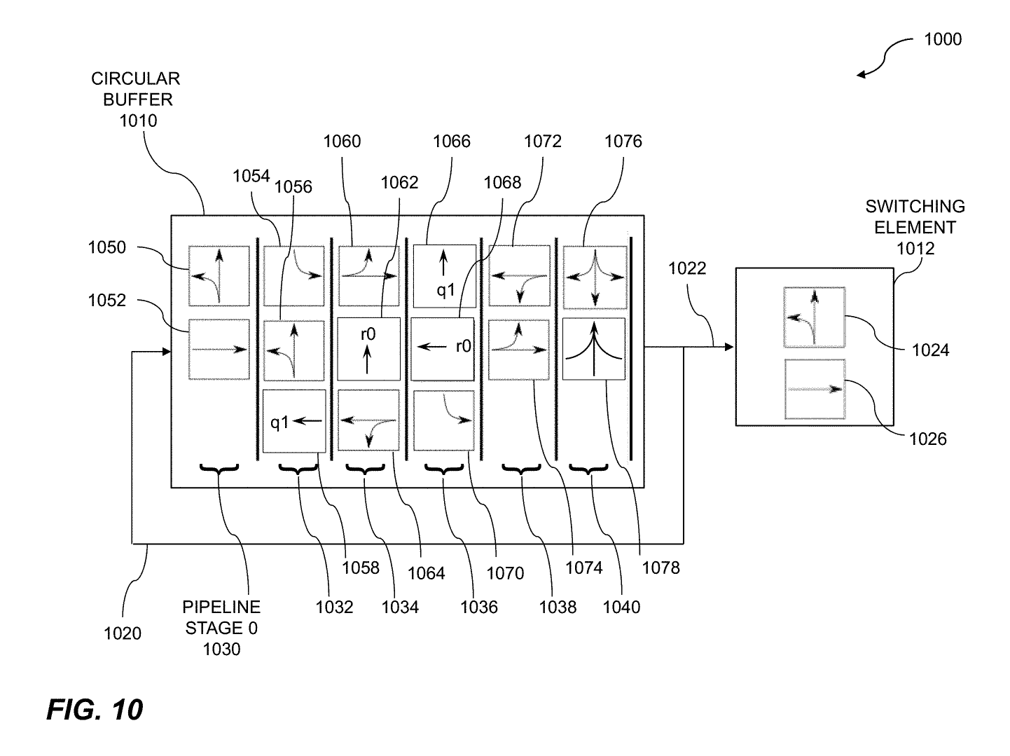

FIG. 10 shows a block diagram of a circular buffer. The circular buffer 1010 can control a switching element 1012 corresponding to the circular buffer. The circular buffer and the corresponding switching element can be used in part for distributed machine learning layers. Using the circular buffer 1010 and the corresponding switching element 1012, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 1000 describes a processor-implemented method for data manipulation. The circular buffer 1010 contains a plurality of pipeline stages. Each pipeline stage contains one or more instructions, up to a maximum instruction depth. In the embodiment shown in FIG. 10, the circular buffer 1010 is a 6×3 circular buffer, meaning that it implements a six-stage pipeline with an instruction depth of up to three instructions per stage (column). Hence, the circular buffer 1010 can include one, two, or three switch instruction entries per column. In some embodiments, the plurality of switch instructions per cycle can comprise two or three switch instructions per cycle. However, in certain embodiments, the circular buffer 1010 supports only a single switch instruction in a given cycle. In the example 1000 shown, Pipeline Stage 0 1030 has an instruction depth of two instructions 1050 and 1052. Though the remaining pipeline stages 1-5 are not textually labeled in the FIG. 1000, the stages are indicated by callouts 1032, 1034, 1036, 1038 and 1040. Pipeline stage 1 1032 has an instruction depth of three instructions 1054, 1056, and 1058. Pipeline stage 2 1034 has an instruction depth of three instructions 1060, 1062, and 1064. Pipeline stage 3 1036 also has an instruction depth of three instructions 1066, 1068, and 1070. Pipeline stage 4 1038 has an instruction depth of two instructions 1072 and 1074. Pipeline stage 5 1040 has an instruction depth of two instructions 1076 and 1078. In embodiments, the circular buffer 1010 includes 64 columns. During operation, the circular buffer 1010 rotates through configuration instructions. The circular buffer 1010 can dynamically change operation of the logical elements based on the rotation of the circular buffer. The circular buffer 1010 can comprise a plurality of switch instructions per cycle for the configurable connections.

The instruction 1052 is an example of a switch instruction. In embodiments, each cluster has four inputs and four outputs, each designated within the cluster's nomenclature as “north,” “east,” “south,” and “west” respectively. For example, the instruction 1052 in the diagram 1000 is a west-to-east transfer instruction. The instruction 1052 directs the cluster to take data on its west input and send out the data on its east output. In another example of data routing, the instruction 1050 is a fan-out instruction. The instruction 1050 instructs the cluster to take data from its south input and send out on the data through both its north output and its west output. The arrows within each instruction box indicate the source and destination of the data. The instruction 1078 is an example of a fan-in instruction. The instruction 1078 takes data from the west, south, and east inputs and sends out the data on the north output. Therefore, the configurable connections can be considered to be time multiplexed.

In embodiments, the clusters implement multiple storage elements in the form of registers. In the example 1000 shown, the instruction 1062 is a local storage instruction. The instruction 1062 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is complete. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep and awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 1058 is a processing instruction. The instruction 1058 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 1000 shown, the circular buffer 1010 rotates instructions in each pipeline stage into switching element 1012 via a forward data path 1022, and also back to a pipeline stage 0 1030 via a feedback data path 1020. Instructions can include switching instructions, storage instructions, and processing instructions, among others. The feedback data path 1020 can allow instructions within the switching element 1012 to be transferred back to the circular buffer. Hence, the instructions 1024 and 1026 in the switching element 1012 can also be transferred back to pipeline stage 0 as the instructions 1050 and 1052. In addition to the instructions depicted on FIG. 10, a no-op instruction can also be inserted into a pipeline stage. In embodiments, a no-op instruction causes execution to not be performed for a given cycle. In effect, the introduction of a no-op instruction can cause a column within the circular buffer 1010 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 1058, assuming that the processor q1 was previously in a sleep state. In embodiments, when the instruction 1058 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 1066. In the case of the instruction 1066, data from the processor q1 is moved to the north output. In some embodiments, if Xs have been placed into the processor q1, such as during the instruction 1058, then Xs would be retrieved from the processor q1 during the execution of the instruction 1066 and would be applied to the north output of the instruction 1066.

A collision occurs if multiple instructions route data to a particular port in a given pipeline stage. For example, if instructions 1052 and 1054 are in the same pipeline stage, they will both send data to the east output at the same time, thus causing a collision since neither instruction is part of a time-multiplexed fan-in instruction (such as the instruction 1078). To avoid potential collisions, certain embodiments use preprocessing, such as by a compiler, to arrange the instructions in such a way that there are no collisions when the instructions are loaded into the circular buffer. Thus, the circular buffer 1010 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 1062), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that keeps track of the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

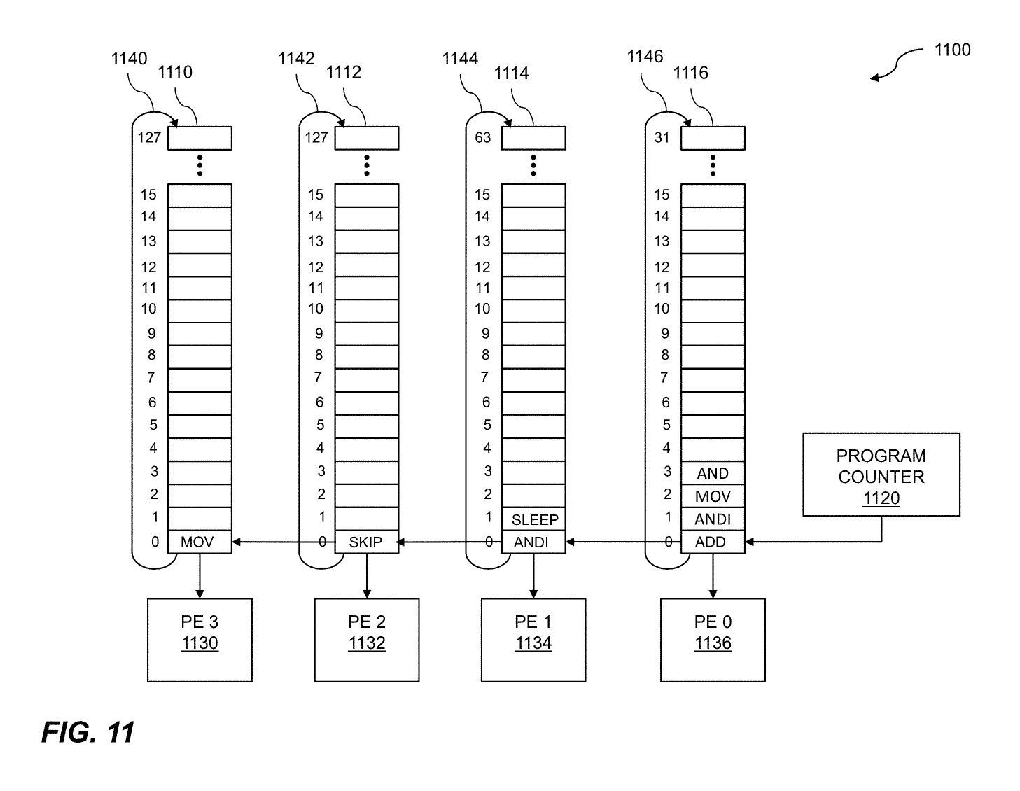

FIG. 11 illustrates circular buffers and processing elements. A diagram 1100 indicates example instruction execution for processing elements. The processing elements can include a portion of or all of the elements within a reconfigurable fabric. The instruction execution can include instructions for distributed machine learning layers. A first data group is obtained in a first locality. The first data group is applied to a first localized machine learning construct. The first learning construct can be a retail establishment, a vehicle, and so on. A first set of convolutional layers is determined within the first localized machine learning construct based on the first data group, where the first set of convolutional layers includes a first data flow graph machine. Similarity is adjudicated between the first localized machine learning construct and a second localized machine learning construct. The first set of convolutional layers is sent to a second localized machine learning construct, based on the similarity that was adjudicated meeting a threshold. A second data group is analyzed by the second localized machine learning construct using the first set of convolutional layers.

A circular buffer 1110 feeds a processing element 1130. A second circular buffer 1112 feeds another processing element 1132. A third circular buffer 1114 feeds another processing element 1134. A fourth circular buffer 1116 feeds another processing element 1136. The four processing elements 1130, 1132, 1134, and 1136 can represent a quad of processing elements. In embodiments, the processing elements 1130, 1132, 1134, and 1136 are controlled by instructions received from the circular buffers 1110, 1112, 1114, and 1116. The circular buffers can be implemented using feedback paths 1140, 1142, 1144, and 1146, respectively. In embodiments, the circular buffer can control the passing of data to a quad of processing elements through switching elements, where each of the quad of processing elements is controlled by four other circular buffers (as shown in the circular buffers 1110, 1112, 1114, and 1116) and where data is passed back through the switching elements from the quad of processing elements, where the switching elements are again controlled by the main circular buffer. In embodiments, a program counter 1120 is configured to point to the current instruction within a circular buffer. In embodiments with a configured program counter, the contents of the circular buffer are not shifted or copied to new locations on each instruction cycle. Rather, the program counter 1120 is incremented in each cycle to point to a new location in the circular buffer. The circular buffers 1110, 1112, 1114, and 1116 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the first two circular buffers 1110 and 1112 have a length of 128 instructions, the third circular buffer 1114 has a length of 64 instructions, and the fourth circular buffer 1116 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 11, different circular buffers can have different instruction sets within them. For example, the first circular buffer 1110 contains a MOV instruction. The second circular buffer 1112 contains a SKIP instruction. The third circular buffer 1114 contains a SLEEP instruction and an ANDI instruction. The fourth circular buffer 1116 contains an AND instruction, a MOVE instruction, an ANDI instruction, and an ADD instruction. The operations performed by the processing elements 1130, 1132, 1134, and 1136 are dynamic and can change over time, based on the instructions loaded into the respective circular buffers. As the circular buffers rotate, new instructions can be executed by the respective processing element.

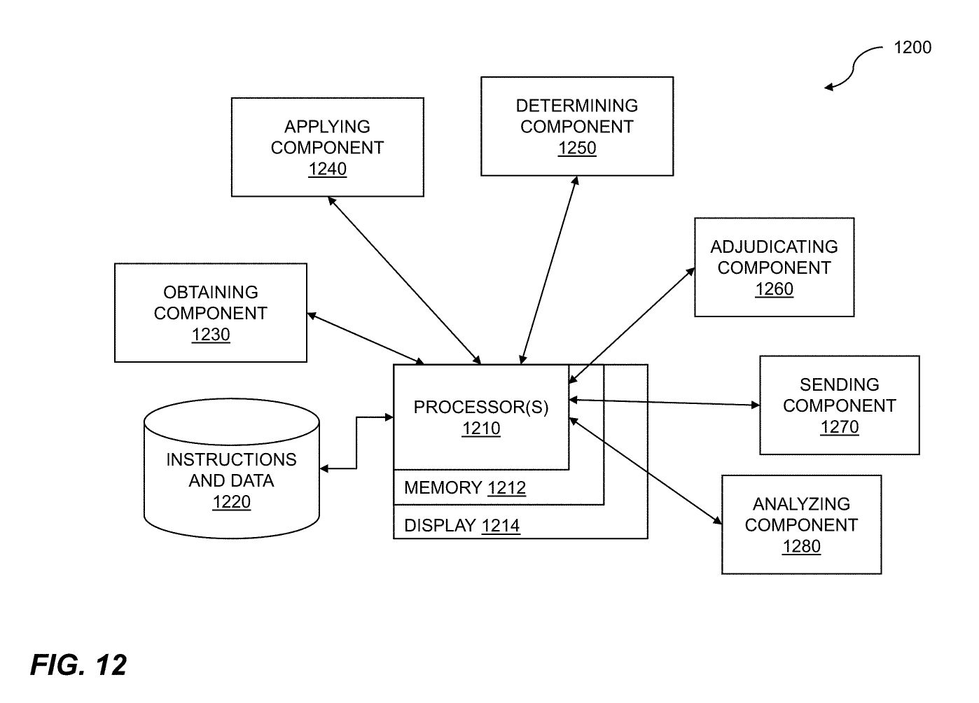

FIG. 12 is a system diagram for distributed machine learning layers. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 are attached to the memory 1212 where the one or more processors, when executing the instructions which are stored, are configured to: obtain a first data group in a first locality; apply the first data group to a first localized machine learning construct; determine a first set of convolutional layers within the first localized machine learning construct based on the first data group wherein the first set of convolutional layers comprises a first data flow graph machine; adjudicate similarity between the first localized machine learning construct and a second localized machine learning construct; send the first set of convolutional layers to the second localized machine learning construct, based on the similarity that was adjudicated meeting a threshold; and analyze a second data group by the second localized machine learning construct using the first set of convolutional layers.

The system 1200 can include a collection of instructions and data 1220. The instructions and data 1220 may be stored in a database, one or more statically linked libraries, one or more dynamically linked libraries, precompiled headers, source code, flow graphs, or other suitable formats. The instructions can include instructions for joining data from one or more upstream processing elements in a reconfigurable fabric. The instructions can include machine-learned layers. The system 1200 can include an obtaining component 1230. The obtaining component can include functions and instructions for obtaining a first data group in a first locality. The first locality can include a geographic locality such as a city or a town, global positioning system (GPS) coordinates, etc. The system 1200 can include an applying component 1240. The applying component 1240 can include functions and instructions for applying the first data group to a first localized machine learning construct. The first localized machine learning construct can include a retail establishment, a vehicle, and so on.

The system 1200 can include a determining component 1250. The determining component can include functions and instructions for determining a first set of convolutional layers within the first localized machine learning construct based on the first data group wherein the first set of convolutional layers comprises a first data flow graph machine. In embodiments, the convolutional layers can include a convolutional neural network, a recurrent neural network, a deep neural network, etc. The system 1200 can include an adjudicating component 1260. The adjudicating component 1260 can include functions and instructions for adjudicating similarity between the first localized machine learning construct and a second localized machine learning construct. A similarity between the first localized machine learning construct and the second localized machine learning construct can be determined using various techniques. The similarity can be adjudicated based on a machine learning construct context for the first localized machine learning construct and the second localized machine learning construct. The machine learning construct context can include the first localized machine learning construct and the second localized machine learning construct referring to retail establishments, vehicles, and so on.

The system 1200 can include a sending component 1270. The sending component 1270 can include functions and instructions for sending the first set of convolutional layers to the second localized machine learning construct, based on the similarity that was adjudicated meeting a threshold. The sending can include sending the first set of convolutional layers via a computer network or other network, where the computer network or other network can include a wired network, a wireless network, a hybrid network, and so on. The computer network can include a mesh network. The system 1200 can include an analyzing component 1280. The analyzing component 1280 can include functions and instructions for analyzing a second data group by the second localized machine learning construct using the first set of convolutional layers. The second data group can be similar to the first data group. The threshold can be updated based on the analyzing a second group of data by the second localized machine learning construct. The analyzing can be used to determine one or more recommendations, where the recommendations can include recommendations for goods, services, amenities, and the like. In embodiments, the analyzing can include determining a sales recommendation for a retail establishment associated with the second localized machine learning construct.

The system 1200 can include a computer program product embodied in a non-transitory computer readable medium for data analysis, the computer program product comprising code which causes one or more processors to perform operations of: obtaining a first data group in a first locality; applying the first data group to a first localized machine learning construct; determining a first set of convolutional layers within the first localized machine learning construct based on the first data group wherein the first set of convolutional layers comprises a first data flow graph machine; adjudicating similarity between the first localized machine learning construct and a second localized machine learning construct; sending the first set of convolutional layers to the second localized machine learning construct, based on the similarity that was adjudicated meeting a threshold; and analyzing a second data group by the second localized machine learning construct using the first set of convolutional layers.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage, an electronic, magnetic, optical, electromagnetic, infrared, or semiconductor computer readable storage medium or any suitable combination of the foregoing, a portable computer diskette, a hard disk, a random access memory (RAM), a read-only memory (ROM), an erasable programmable read-only memory (EPROM, Flash, MRAM, FeRAM, or phase change memory), an optical fiber, a portable compact disc, an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention, rather it should be understood in the broadest sense allowable by law.

What is claimed is:

1. A computer-implemented method for data analysis comprising:
obtaining a first data group in a first locality;
applying the first data group to a first localized machine learning construct;
determining a first set of convolutional layers within the first localized machine learning construct based on the first data group wherein the first set of convolutional layers comprises a first data flow graph machine;
adjudicating similarity between the first localized machine learning construct and a second localized machine learning construct;
sending the first set of convolutional layers to the second localized machine learning construct, based on the similarity that was adjudicated meeting a threshold; and
analyzing a second data group by the second localized machine learning construct using the first set of convolutional layers.

2. The method of claim 1 wherein the similarity is adjudicated based on machine learning construct context for the first localized machine learning construct and the second localized machine learning construct.

3. The method of claim 1 wherein the threshold is updated based on the analyzing a second group of data by the second localized machine learning construct.

4. The method of claim 1 wherein the first localized machine learning construct comprises a first retail establishment.

5. The method of claim 4 wherein the second localized machine learning construct comprises a second retail establishment.

6. The method of claim 1 wherein the analyzing comprises determining a sales recommendation for a retail establishment associated with the second localized machine learning construct.

7-8. (canceled)

9. The method of claim 1 wherein the first localized machine learning construct comprises a first vehicle.

10. The method of claim 9 wherein the second localized machine learning construct comprises a second vehicle.

11. The method of claim 10 further comprising transferring descriptors for the first set of convolutional layers using a mesh network comprising the first vehicle and the second vehicle.

12. The method of claim 1 wherein the second localized machine learning construct comprises a second data flow graph machine.

13. The method of claim 12 further comprising augmenting learning from the first localized machine learning construct by the second localized machine learning construct.

14. The method of claim 13 wherein the augmenting learning is accomplished using a second group of data obtained within the second localized machine learning construct.

15. The method of claim 13 further comprising sending results of the augmenting learning to a third machine learning construct.

16. The method of claim 15 further comprising analyzing a third data group by the third machine learning construct using the results of the augmenting learning.

17. The method of claim 12 wherein the first localized machine learning construct comprises a convolutional neural net.

18. The method of claim 1 wherein the determining the first set of convolutional layers comprises machine learning.

19. The method of claim 1 wherein the determining further comprises determining a first set of max pooling layers.

20. The method of claim 1 wherein the determining further comprises determining a first set of hidden layers.

21. The method of claim 1 wherein the determining further comprises determining a first set of weights.

22. The method of claim 21 wherein the determining the first set of weights is accomplished using forward propagation and backward propagation.

23-24. (canceled)

25. The method of claim 1 further comprising applying a fourth data group to the second localized machine learning construct.

26. The method of claim 25 further comprising determining a second set of convolutional layers on the second localized machine learning construct using the fourth data group.

27. A computer program product embodied in a non-transitory computer readable medium for data analysis, the computer program product comprising code which causes one or more processors to perform operations of:
obtaining a first data group in a first locality;
applying the first data group to a first localized machine learning construct;
determining a first set of convolutional layers within the first localized machine learning construct based on the first data group wherein the first set of convolutional layers comprises a first data flow graph machine;
adjudicating similarity between the first localized machine learning construct and a second localized machine learning construct;
sending the first set of convolutional layers to the second localized machine learning construct, based on the similarity that was adjudicated meeting a threshold; and
analyzing a second data group by the second localized machine learning construct using the first set of convolutional layers.

28. A computer system for data analysis comprising:
a memory which stores instructions;
one or more processors attached to the memory wherein the one or more processors, when executing the instructions which are stored, are configured to:
obtain a first data group in a first locality;
apply the first data group to a first localized machine learning construct;
determine a first set of convolutional layers within the first localized machine learning construct based on the first data group wherein the first set of convolutional layers comprises a first data flow graph machine;
adjudicate similarity between the first localized machine learning construct and a second localized machine learning construct;
send the first set of convolutional layers to the second localized machine learning construct, based on the similarity that was adjudicated meeting a threshold; and
analyze a second data group by the second localized machine learning construct using the first set of convolutional layers.
